(19) United States
(12) Patent Application Publication
(10) Pub. No.: US 2016/0283062 A1
(43) Pub. Date: Sep. 29, 2016

(54) STORAGE MEDIUM, FACILITY INSPECTION SUPPORT METHOD, AND FACILITY INSPECTION SUPPORT APPARATUS

(71) Applicant: FUJITSU LIMITED, Kawasaki-shi (JP)

(72) Inventors: Yuta SHIOIRI, Kawasaki (JP); IWAO KAKEGAWA, Kawasaki (JP); Toshiyuki Maruyama, Kawasaki (JP); Yoko Saito, Kawasaki (JP)

(73) Assignee: FUJITSU LIMITED, Kawasaki-shi (JP)

(21) Appl. No.: 15/174,123

(22) Filed: Jun. 6, 2016

Related U.S. Application Data
(63) Continuation of application No. PCT/JP2013/083333, filed on Dec. 12, 2013.

(51) Int. Cl. G06F 3/0482; G06F 3/0484

(52) U.S. Cl. CPC G06F 3/0482; G06F 3/0484

(57) ABSTRACT

A non-transitory computer-readable storage medium stores a program that causes a computer to execute a process. The process includes displaying pointers indicating inspection points on a map of a facility, displaying a first input screen for receiving an inspection result of an inspection point corresponding to a first pointer of the pointers, receiving an input that is an instruction for switching to another screen from the first input screen, and in response to the input, allowing the first input screen to be switched to a second input screen for receiving an inspection result of an inspection point corresponding to a second pointer of the pointers that precedes the first pointer in a predetermined order of inspection.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2013/083333, filed on Dec. 12, 2013, the entire contents of which are incorporated herein by reference.

### FIELD

An aspect of this disclosure relates to a storage medium, a facility inspection support method, and a facility inspection support apparatus.

### BACKGROUND

Japanese Laid-Open Patent Publication No. 2011-186621 discloses a system that supports inspection of facilities in, for example, a factory. The disclosed system identifies the next inspection point based on an inspection route.

Thus, the disclosed system supports an inspector to visit and inspect inspection points in a predetermined order. However, the disclosed system is not capable of dynamically changing the order in which inspection points are inspected and dynamically adding an inspection point.

### SUMMARY

According to an aspect of this disclosure, there is provided a non-transitory computer-readable storage medium storing a program that causes a computer to execute a process. The process includes displaying pointers indicating inspection points on a map of a facility, displaying a first input screen for receiving an inspection result of an inspection point corresponding to a first pointer of the pointers, receiving an input that is an instruction for switching to another screen from the first input screen, and in response to the input, allowing the first input screen to be switched to a second input screen for receiving an inspection result of an inspection point corresponding to a second pointer of the pointers that precedes the first pointer in a predetermined order of inspection.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a drawing illustrating an exemplary configuration of a facility inspection support system;

FIG. 2 is a table illustrating an exemplary pin definition database;

FIG. 3 is a table illustrating an exemplary pin record database;

FIG. 4 is a table illustrating an exemplary route definition database;

FIG. 5 is a table illustrating an exemplary route record database;

FIG. 6 is a table illustrating an exemplary map definition database;

FIGS. 7A through 7C are drawings illustrating exemplary maps;

FIG. 8 is a block diagram illustrating an exemplary hardware configuration of a terminal;

FIG. 9 is a drawing illustrating an exemplary functional configuration of a facility inspection support system;

FIG. 10 is a flowchart illustrating an exemplary process performed by a terminal and a server;

FIG. 11 is a drawing illustrating an exemplary inspection route list screen;

FIG. 12 is a drawing illustrating a screen displaying inspection points and an inspection order;

FIG. 13 is a flowchart illustrating an exemplary process of displaying input screens for entering inspection results;

FIG. 14 is a drawing illustrating an exemplary input screen corresponding to an inspection pin;

FIG. 15 is a flowchart illustrating an exemplary process of inserting an inspection pin;

FIG. 16 is a drawing illustrating an exemplary screen used to describe insertion of an inspection pin;

FIG. 17 is a flowchart illustrating an exemplary process of switching maps;

FIG. 18 is a drawing illustrating an exemplary map screen;

FIG. 19 is a drawing illustrating an exemplary map screen;

FIG. 20 is a drawing illustrating an exemplary map screen;

FIG. 21 is a drawing illustrating an exemplary map screen; and

FIG. 22 is a drawing illustrating an exemplary map screen.

### DESCRIPTION OF EMBODIMENTS

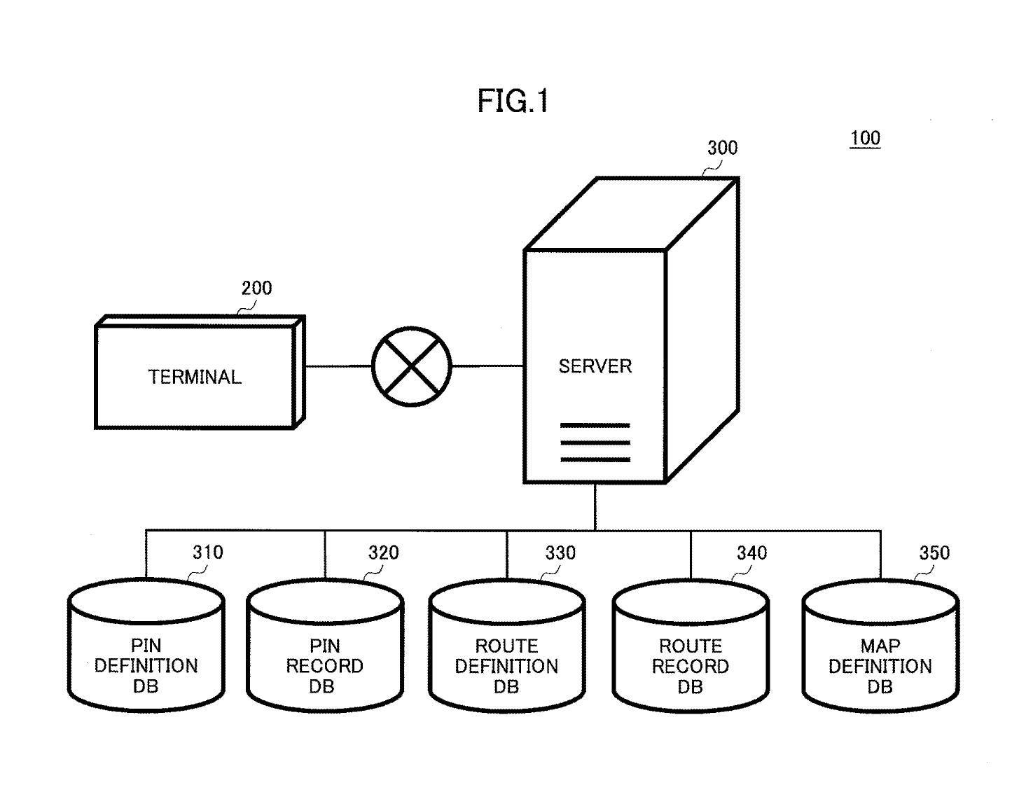

Embodiments of the present invention are described below with reference to the accompanying drawings. FIG. 1 is a drawing illustrating an exemplary configuration of a facility inspection support system 100.

The facility inspection support system 100 may include a terminal 200 and a server 300 that are connected to each other via a network.

The facility inspection support system 100 supports an inspector to inspect various types of facilities in, for example, a factory or a plant such as a power plant.

The server 300 may include a pin definition database (DB) 310, a pin record database (DB) 320, a route definition database (DB) 330, a route record database (DB) 340, and a map definition database (DB) 350.

When a facility inspection support program is started by an inspector, the terminal 200 supports inspection work of the inspector. More specifically, the terminal 200 refers to the pin definition database 310, the route definition database 330, and the map definition database 350, and displays pointers (which are hereafter referred to as “pins”) indicating inspection points based on an inspection route. Also, by referring to the pin definition database 310, the terminal 200 displays input screens in the order of inspection to allow the inspector to enter inspection results. Each input screen includes input fields for entering information items corresponding to a pin. When inspection results are entered for all pins included in the inspection route, the terminal 200 sends the inspection results to the server 300 and requests the server 300 to store the inspection results in the pin record database 320 and the route record database 340.

As described above, the terminal 200 displays input screens corresponding to pins in the order of inspection and allows an inspector to enter inspection results. Thus, the terminal 200 functions as a facility inspection support apparatus that supports inspection work of an inspector.

The terminal 200 can also switch inspection screens according to an instruction of an inspector, and allows the inspector to inspect inspection points in an order different from a predetermined inspection order. In other words, the terminal 200 can change the predetermined inspection order.

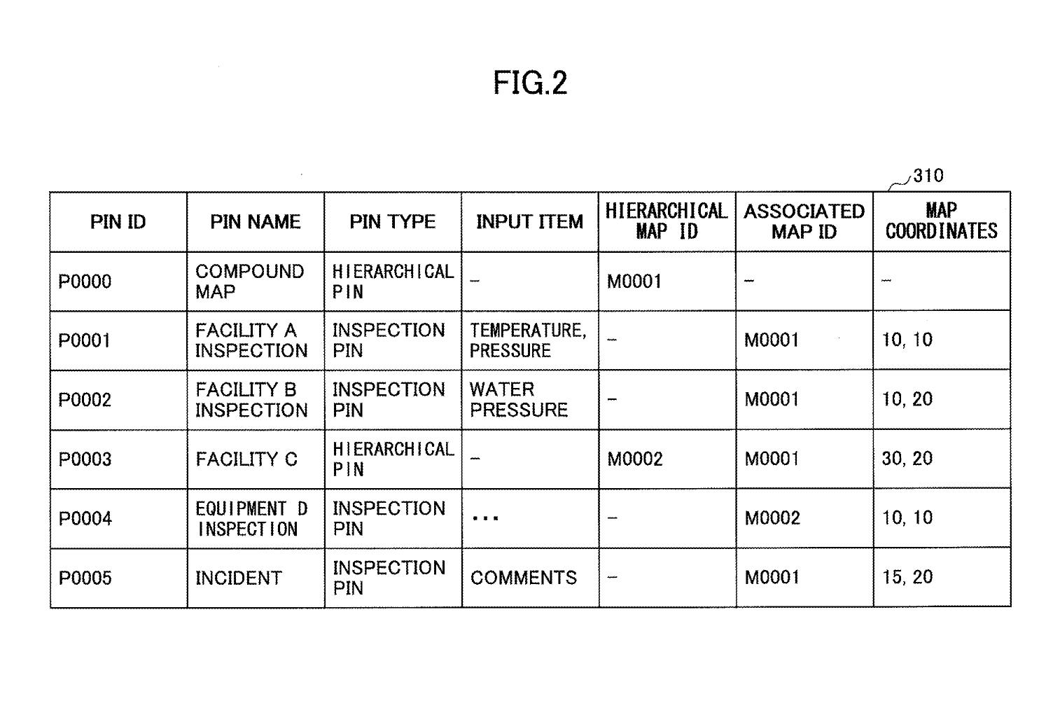

Next, databases included in the server 300 are described with reference to FIGS. 2 through 6.

FIG. 2 is a table illustrating an example of the pin definition database 310.

The pin definition database 310 includes, as information items (fields), a pin ID; and a pin name, a pin type, one or more input items, a hierarchical map ID, an associated map ID, and map coordinates that are associated with the pin ID. In the descriptions below, information items associated with a pin ID in the pin definition database 310 are referred to as “pin information”.

The pin ID is an identifier for identifying a pin. The pin name is the name of a pin. The pin type indicates the type of a pin. In the present embodiment, there are two types of pins: a hierarchical pin and an inspection pin. The hierarchical pin indicates a hierarchical level of a map. The inspection pin indicates an inspection point in a map.

Each input item is an information item input as an inspection result and corresponds to an input field in an input screen. In the present embodiment, one or more input items are associated with and determined for each inspection pin.

The hierarchical map ID is associated with a hierarchical pin, and is a map ID that indicates a map in a hierarchical level indicated by the hierarchical pin. The associated map ID is associated with an inspection pin or a hierarchical pin, and is a map ID that indicates a map (associated map) including the inspection pin or the hierarchical pin. The map coordinates are associated with an inspection pin or a hierarchical pin and indicate a position of the inspection pin or the hierarchical pin in a map including the inspection pin or the hierarchical pin.

In the example of FIG. 2, a pin ID “P0000” indicates a hierarchical pin whose name is “compound map”. The hierarchical pin with the pin ID “P0000” is associated with a map ID “M0001”. A pin ID “P0001” indicates an inspection pin whose name is “facility A inspection”. The inspection pin with the pin ID “P0001” is associated with input items “temperature” and “pressure”, and is located at coordinates (10, 10) in a map with the map ID “M0001”. Hereafter, for brevity, a pin with a pin ID “PXXXX” may be referred to as a pin “PXXXX”, and a map with a map ID “MXXXX” may be referred to as a map “MXXXX”.

Also in the example of FIG. 2, a pin ID “P0003” indicates a hierarchical pin whose name is “facility C”. The hierarchical pin “P0003” belongs to the map “M0001”, is located at coordinates (30, 20), and is also associated with a map ID “M0002”. Thus, the hierarchical pin “P0003” defines a hierarchy of the map “M0001” and the map “M0002”.

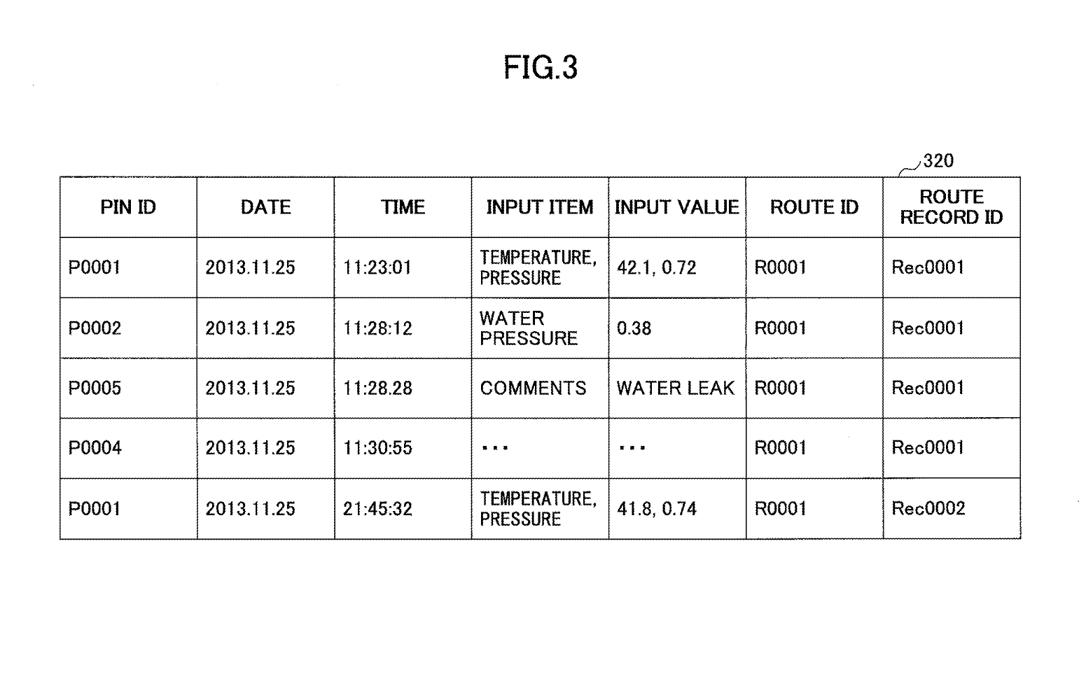

FIG. 3 is a table illustrating an example of the pin record database 320.

The pin record database 320 stores inspection results for each inspection pin.

The pin record database 320 includes, as information items (fields), a pin ID; and a date, a time, one or more input items, one or more input values, a route ID, and a route record ID that are associated with the pin ID. In the descriptions below, information items associated with a pin ID in the pin record database 320 are referred to as “pin record information”.

In the pin record database 320 of the present embodiment, the date and the time indicate when an input value is entered in an input item. The input item indicates an information item to be entered as an inspection result for the corresponding inspection pin, and the input value indicates an actual value entered for the input item.

The route ID is an identifier for identifying an inspection route including the inspection pin. The route record ID is an identifier for identifying inspection results of the corresponding inspection route.

In the example of FIG. 3, as an inspection result of an inspection pin “P0002”, an input value “0.38” is entered for an input item “water pressure” recorded at 11:28:12 on 2013/11/25. The inspection pin “P0002” is included in an inspection route with a route ID “R0001”, and the inspection result of the inspection pin “P0002” is included in a route record identified by a route record ID “Rec0001”.

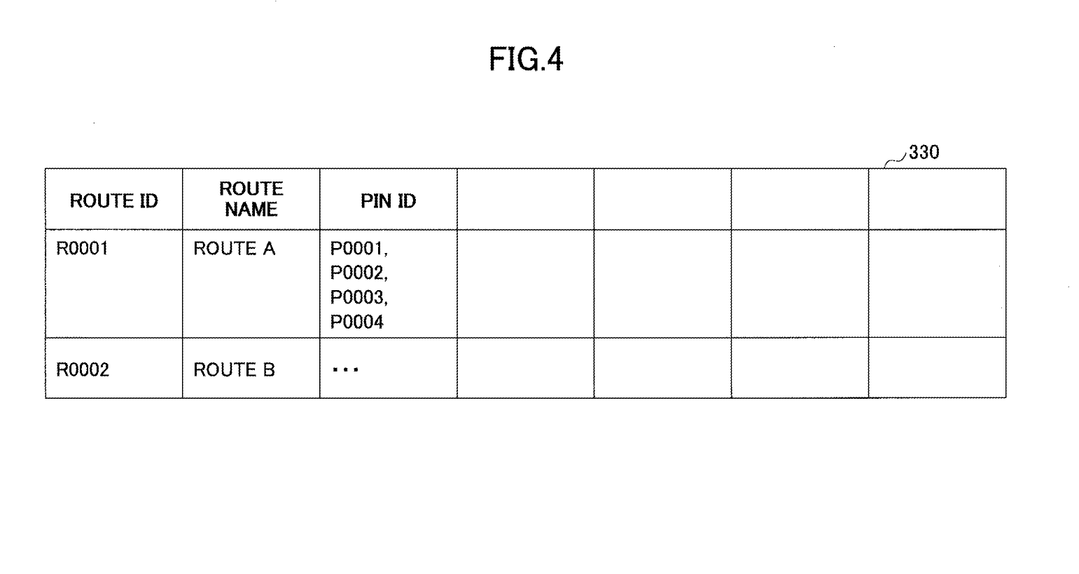

FIG. 4 is a table illustrating an example of the route definition database 330.

The route definition database 330 includes, as information items (fields), a route ID; and a route name and one or more pin IDs that are associated with the route ID. In the descriptions below, information items associated with a route ID in the route definition database 330 are referred to as “route information”.

In the route definition database 330 of the present embodiment, a route ID and one or more pin IDs are associated with each other to indicate that pins with the pin IDs are included in an inspection route identified by the route ID.

In the example of FIG. 4, an inspection route “route A” with a route ID “R0001” includes inspection pins with pin IDs “P0001”, “P0002”, and “P0004” and a hierarchical pin with a pin ID “P0003”.

FIG. 5 is a table illustrating an example of the route record database 340.

The route record database 340 includes, as information items (fields), a route ID; and a route record ID, status, a completed date, and a completed time that are associated with the route ID. In the descriptions below, information items associated with a route ID in the route record database 340 are referred to as “route record information”.

In the route record database 340, the status indicates the status of inspection of an inspection route indicated by the corresponding route ID. The completed date and the completed time indicate when the inspection of the inspection route indicated by the route ID is completed.

In the example of FIG. 5, the inspection of an inspection route with a route ID “R0001” is completed at 11:32:30 on 2013/11/25 and its inspection results are recorded in association with a route record ID “Rec0001”.

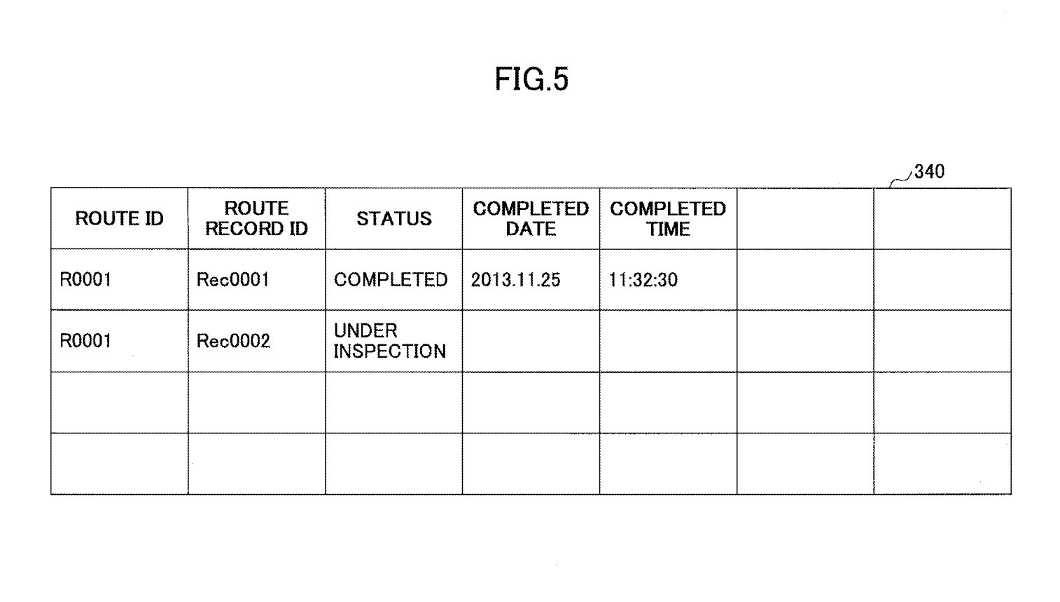

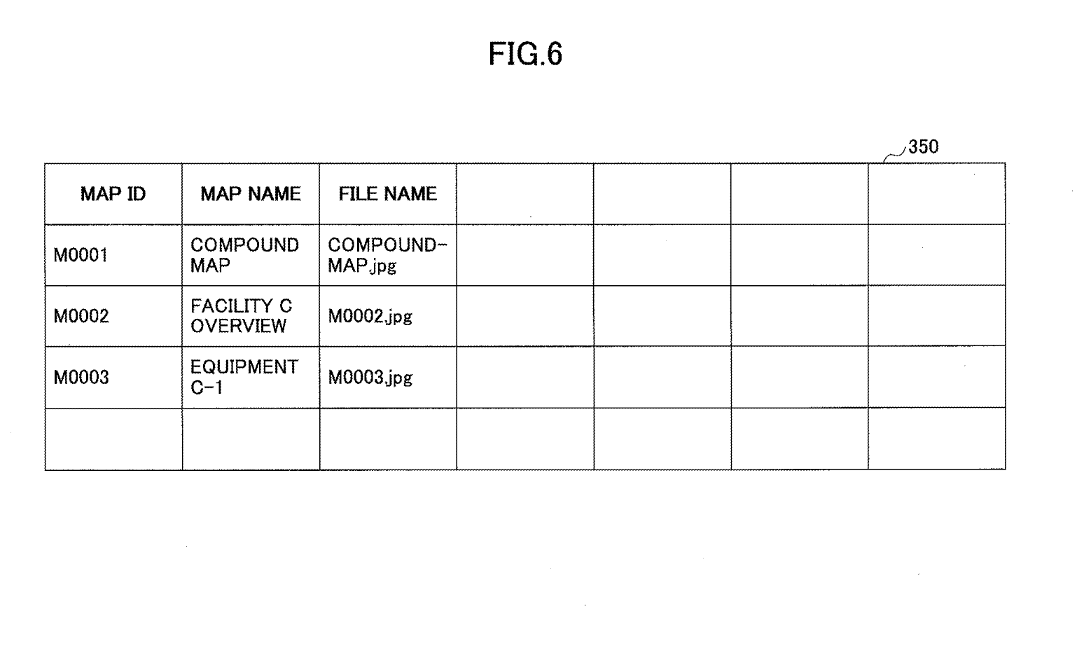

FIG. 6 is a table illustrating an example of the map definition database 350.

The map definition database 350 includes, as information items (fields), a map ID; and a map name and a file name that are associated with the map ID. In the descriptions below, information items associated with a map ID in the map definition database 350 are referred to as “map information”.

The map name is the name of a map, and the file name indicates a file used by the terminal 200 to display the map.

In the example of FIG. 6, a map with a map ID “M0001” has a name “compound map”, and the name of a file used to display the map is “compound-map.jpg”.

The map definition database 350 of the present embodiment stores files representing maps in different hierarchical levels. For example, the map definition database 350 may store a file of a map of the entire area of a factory to be inspected, a file of a map of a facility in the factory, and a file of a map of equipment in the facility.

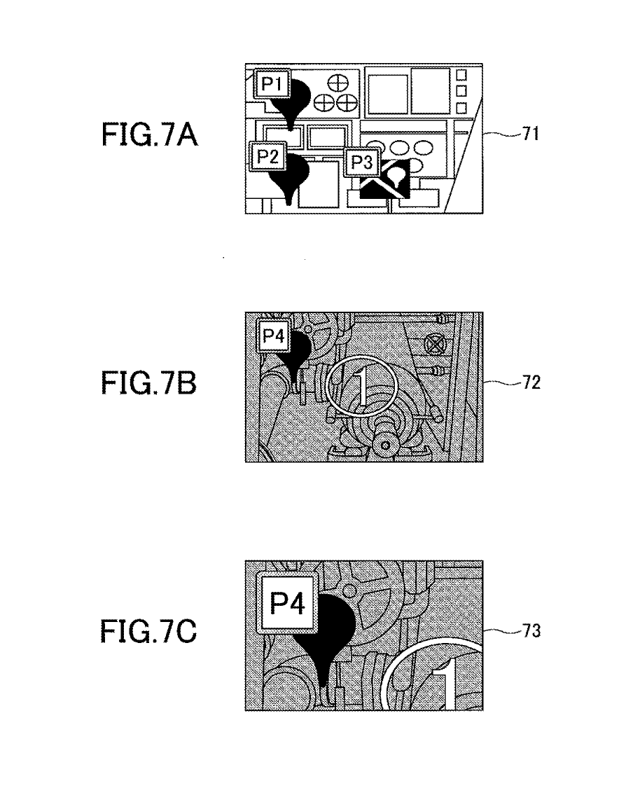

The hierarchy of maps is described with reference to FIGS. 7A through 7C. FIGS. 7A through 7C are drawings illustrating exemplary maps. FIG. 7A illustrates a map 71 in a first hierarchical level, FIG. 7B illustrates a map 72 in a second hierarchical level, and FIG. 7C illustrates a map 73 that is an enlarged view of an inspection point in the second hierarchical level.

The map 71 of FIG. 7A represents an area where various facilities are present. The map 71 is, for example, the compound map “M0001” stored in the map definition database 350. On the map 71, a hierarchical pin P3, an inspection pin P1, and an inspection pin P2 are displayed. In the present embodiment, hierarchical pins and inspection pins are preferably displayed on a map using icon images corresponding to their pin types.

The map 72 of FIG. 7B is in a hierarchical level below the hierarchical level of the map 71, and is a schematic view of a facility in an area indicated by the hierarchical pin P3 in the map 71. That is, the map 72 represents details of the area indicated by the hierarchical pin P3 in the map 71. The map 72 is, for example, the map “M0002” of the facility C stored in the map definition database 350. On the map 72, an inspection pin P4 is displayed. The inspection pin P4 indicates equipment to be inspected in the facility represented by the map 72.

The map 73 of FIG. 7C is an enlarged view of an inspection point in the map 72. For example, the map represents the layout of equipment that is to be inspected and indicated by the inspection pin P4.

Thus, in the present embodiment, an image illustrating more details of an inspection point is displayed by the terminal 200 in the lower level of hierarchy. In the present embodiment, the hierarchical relationship between maps stored in the map definition database 350 is indicated by, for example, pins associated with the maps and an inspection route including the pins.

The map definition database 350 stores, for example, names of files (e.g., image data) of the map 71, the map 72, and the map 73 in association with map IDs and map names. The actual files of the maps 71, 72, and 73 may be stored in the map definition database 350 or in another storage device.

The map definition database 350 may also store information indicating the hierarchical relationship between maps in association with map IDs. For example, the map “M0002” is in a hierarchical level that is one level below the hierarchical level of the map “M0001”. In this case, information “M0001−1” indicating the hierarchical level one level below the hierarchical level of the map “M0001” may be associated with the map ID “M0002”.

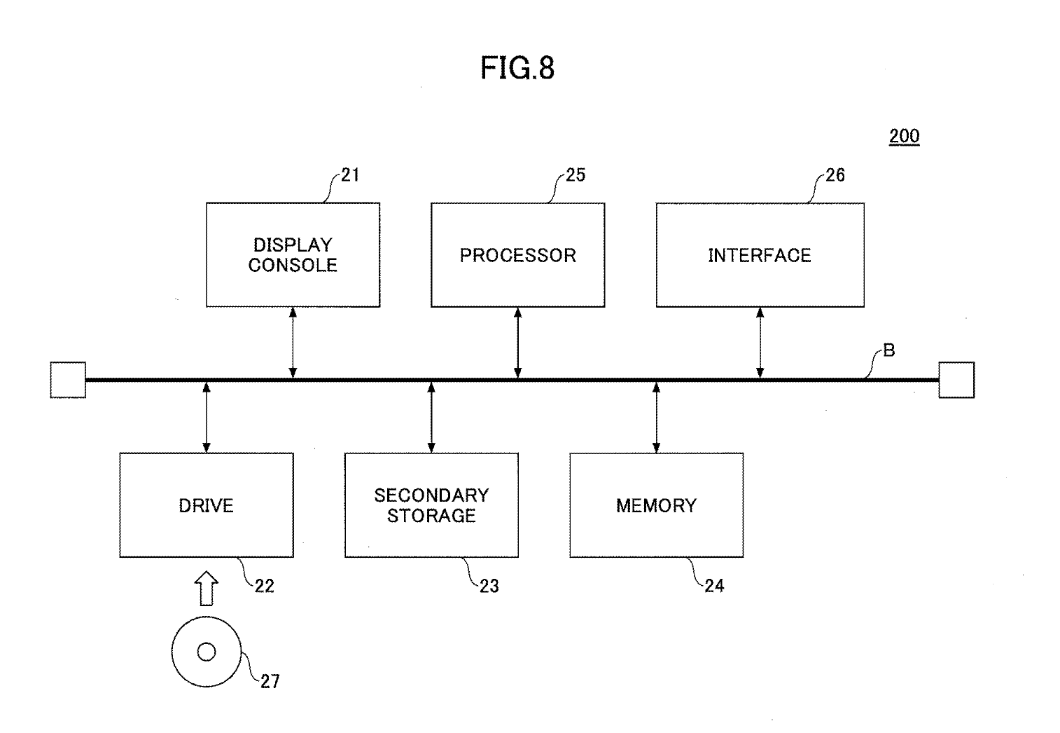

Next, an exemplary hardware configuration of the terminal 200 is described with reference to FIG. 8. FIG. 8 is a block diagram illustrating an exemplary hardware configuration of the terminal 200.

The terminal 200 may include a display console 21, a drive 22, a secondary storage 23, a memory 24, a processor 25, and an interface 26 that are connected to each other via a bus B.

The display console 21 may be implemented by, for example, a touch panel and includes a display function and an information input function. The interface 26 includes, for example, a modem and a LAN card, and is used to connect the terminal 200 to a network.

The terminal 200 may include a facility inspection support program that is one of programs for controlling the terminal 200. For example, the facility inspection support program may be provided via a storage medium 27 or downloaded from a network. Examples of the storage medium 27 for storing the facility inspection support program include storage media such as a compact disk read-only memory (CD-ROM), a flexible disk, and a magneto-optical disk that record information optically, electrically, or magnetically; and semiconductor memories such as a read-only memory (ROM) and a flash memory that record information electrically.

When the storage medium 27 storing the facility inspection support program is set on the drive 22, the facility inspection support program is read by the drive 22 from the storage medium 27 and installed in the secondary storage 23. On the other hand, when the facility inspection support program is downloaded from a network, the facility inspection support program is installed via the interface 26 in the secondary storage 23.

The secondary storage 23 stores the installed facility inspection support program and other necessary files and data. The memory 24 stores the facility inspection support program read from the secondary storage 23 when the terminal 200 (or a computer) is started. The processor 25 executes the facility inspection support program stored in the memory 24 to perform various processes described later.

The terminal 200 may be implemented by, for example, a tablet computer. The server 300 may be implemented by, for example, a general-purpose computer including a processor and a memory.

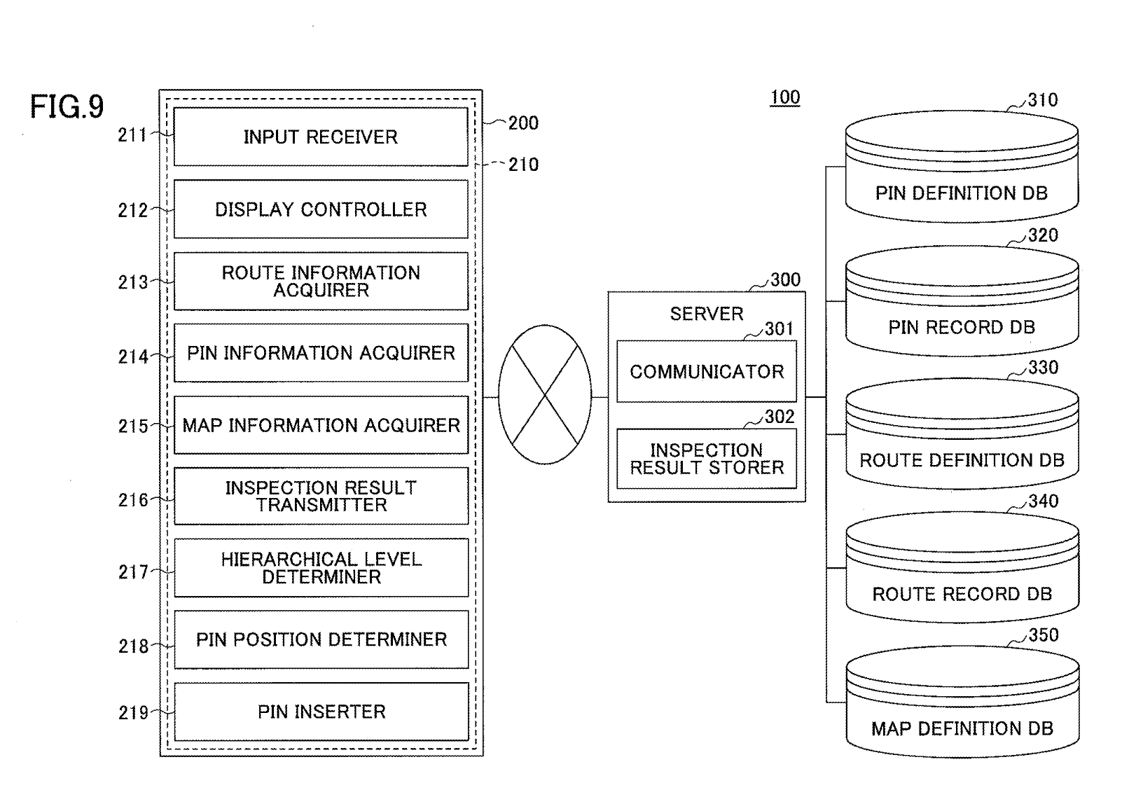

Next, an exemplary functional configuration of the facility inspection support system 100 is described with reference to FIG. 9. FIG. 9 is a drawing illustrating an exemplary functional configuration of the facility inspection support system 100.

A facility inspection support program 210 is installed in the terminal 200. The terminal 200 executes the facility inspection support program 210 to implement various functional units and perform various processes described below.

The terminal 200 may include an input receiver 211, a display controller 212, a route information acquirer 213, a pin information acquirer 214, a map information acquirer 215, an inspection result transmitter 216, a hierarchical level determiner 217, a pin position determiner 218, and a pin inserter 219.

The input receiver 211 receives various inputs or instructions via the display console 21. The display controller 212 controls display of information on the display console 21.

The route information acquirer 213 obtains route information from the route definition database 330 based on an input received by the input receiver 211. The pin information acquirer 214 obtains pin information from the pin definition database 310 based on an input received by the input receiver 211. The map information acquirer 215 obtains map information from the map definition database 350 based on map IDs included in the pin information.

The inspection result transmitter 216 sends inspection results to the server 300 when inspection of a selected inspection route is completed. The hierarchical level determiner 217 determines whether two inspection pins are in the same hierarchical level. More specifically, when two inspection pins are on the same map, the hierarchical level determiner 217 determines that the two inspection pins are in the same hierarchical level.

The pin position determiner 218 determines the position of each inspection pin. More specifically, the pin position determiner 218 determines whether an inspection pin is included in a selected inspection route. When a new inspection pin is set on a map, the pin inserter 219 inserts the inspection pin in an inspection route.

The server 300 may include a communicator 301 and an inspection result storer 302. The communicator 301 communicates with the terminal 200.

The inspection result storer 302 updates the route record database 340 based on inspection results sent from the terminal 200, and stores the inspection results in the pin record database 320.

More specifically, the inspection result storer 302 sets “completed” in the status field of a record in the route record database 340 corresponding to the route ID of an inspection route whose inspection is completed, and stores a route record ID in association with the route ID.

Also, the inspection result storer 302 stores, in the pin record database 320, input values of input items of each inspection pin and the date and time when the input values are entered. Further, the inspection result storer 302 stores the route record ID, which is stored in association with the route ID in the route record database 340, in association with pin IDs in the pin record database 320.

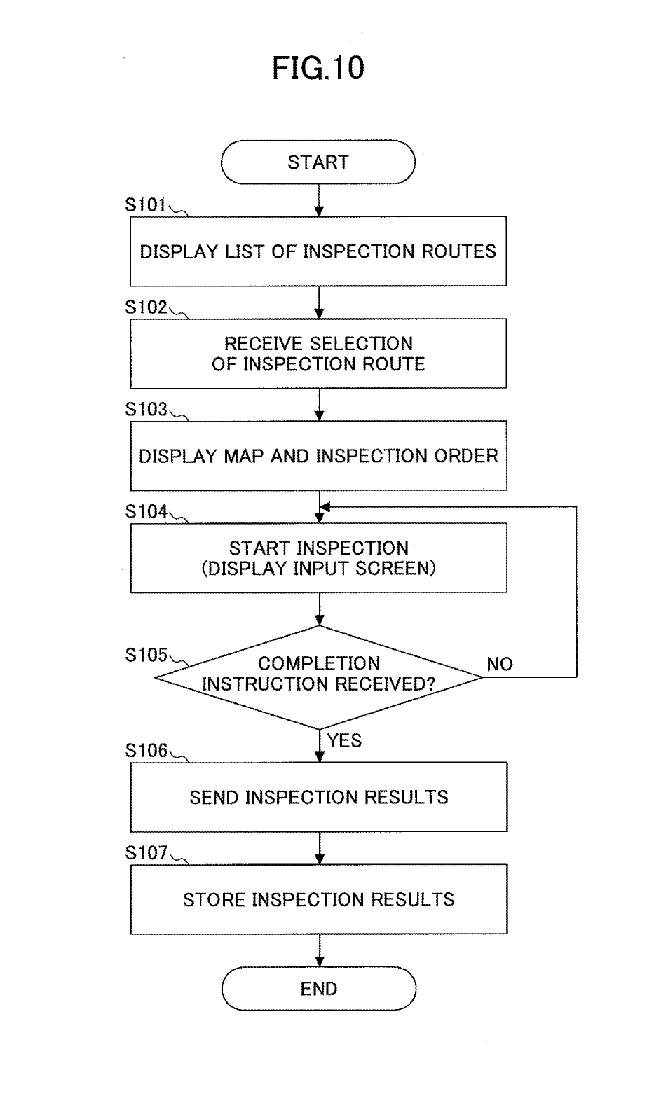

Next, an exemplary process performed by the terminal 200 and the server 300 is described with reference to FIG. 10. FIG. 10 is a flowchart illustrating an exemplary process performed by the terminal 200 and the server 300.

When inspection is started, the route information acquirer 213 of the terminal 200 obtains a list of inspection routes from the route definition database 330, and the display controller 212 displays the list of inspection routes on the display console 21 (step S101). Next, the input receiver 211 receives a selection of an inspection route (step S102).

Then, the terminal 200 displays a map including inspection points and the order of inspection based on the selected inspection route (step S103).

Step S103 is described in more detail below. When an inspection route is selected, the route information acquirer 213 obtains route information of the selected inspection route from the route definition database 330. Next, the pin information acquirer 214 refers to the pin definition database 310 and obtains pin information corresponding to pin IDs in the route information. Then, the map information acquirer 215 obtains map information corresponding to map IDs in the pin information from the map definition database 350.

In step S103 of the present embodiment, a map ID included in pin information corresponding to a pin ID at the top of pin IDs in the route information may be obtained, and a map may be displayed based on map information corresponding to the obtained map ID. With this method, the terminal 200 can display a map including an inspection pin indicating the first inspection point in the inspection route.

The terminal 200 may also display the order of inspection of inspection pins according to the order in which pin IDs are arranged in the obtained route information.

Following step S103, the terminal 200 starts supporting inspection work of an inspector (step S104).

More specifically, the terminal 200 displays an input screen including an input field(s) corresponding to an input item(s) for each inspection pin, and receives a value(s) entered in the input field(s). The terminal 200 retains the received value as an inspection result.

The terminal 200 can also display an input screen corresponding to the next inspection pin or an input screen corresponding to the previous inspection pin according to an input screen switch instruction. Further, when, for example, an inspection pin is set at an inspection point not included in an inspection route, the terminal 200 inserts the inspection pin in the inspection route.

With the above functions, for example, even when it is difficult or inappropriate to continue inspection in a predetermined order or it is desirable to partially change the order of inspection, the terminal 200 enables the inspector to continue inspection by changing the order of inspection. Details of processes of displaying input screens and inserting an inspection pin are described later.

Next, the terminal 200 determines whether a completion report (or completion instruction) indicating completion of the inspection has been received (step S105). When it is determined at step S105 that the completion report has not been received, the terminal 200 returns to step S104. When it is determined at step S105 that the completion report has been received, the terminal 200 sends inspection results to the server 300 (step S106).

When receiving the inspection results, the inspection result storer 302 of the server 300 updates the route record database 340, and stores the inspection results in the pin record database 320 (step S107).

After the completion report is received, the terminal 200 does not switch input screens even when an input screen switch instruction is received. Also after receiving the completion report, the terminal 200 does not accept entry of inspection results.

As described above, in the present embodiment, entry of inspection results is prevented after a completion report indicating completion of inspection is received. This configuration makes it possible to prevent tampering of inspection results.

The terminal 200 may be configured to prevent transmission of inspection results to the server 300 before a completion report is received.

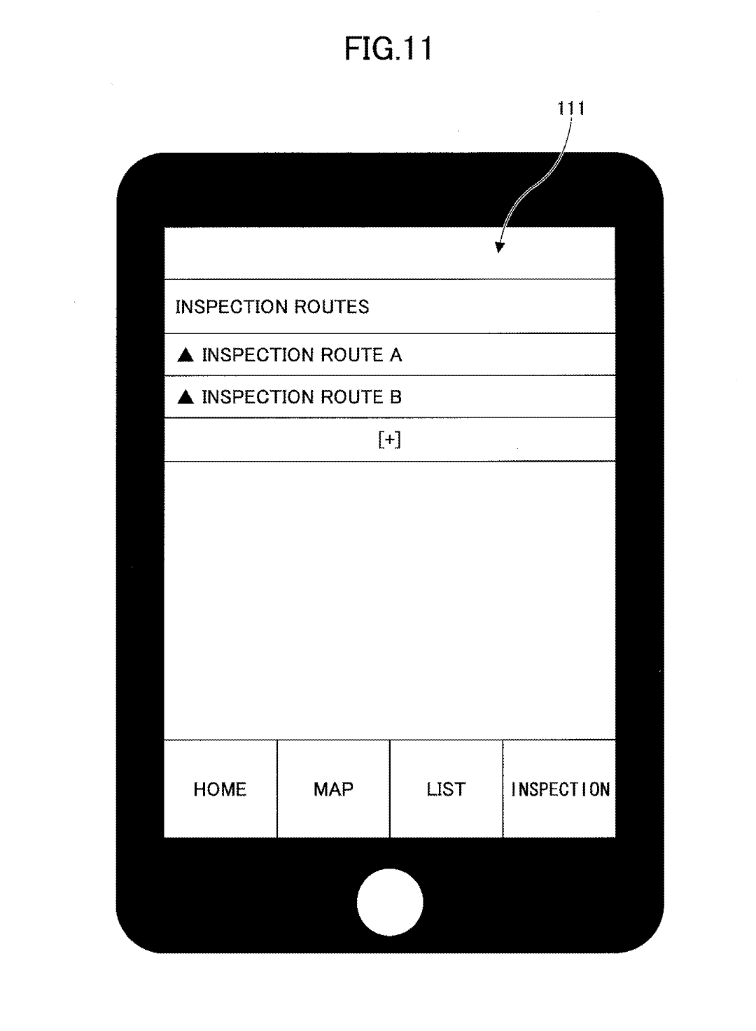

Next, operations of the terminal 200 are described with reference to FIGS. 11 through 13.

FIG. 11 is a drawing illustrating an exemplary inspection route list screen 111. When an instruction to start inspection is received, the terminal 200 displays the inspection route list screen 111 illustrated by FIG. 11. When an inspection route is selected on the inspection route list screen 111, the terminal 200 obtains route information corresponding to the name of the selected inspection route.

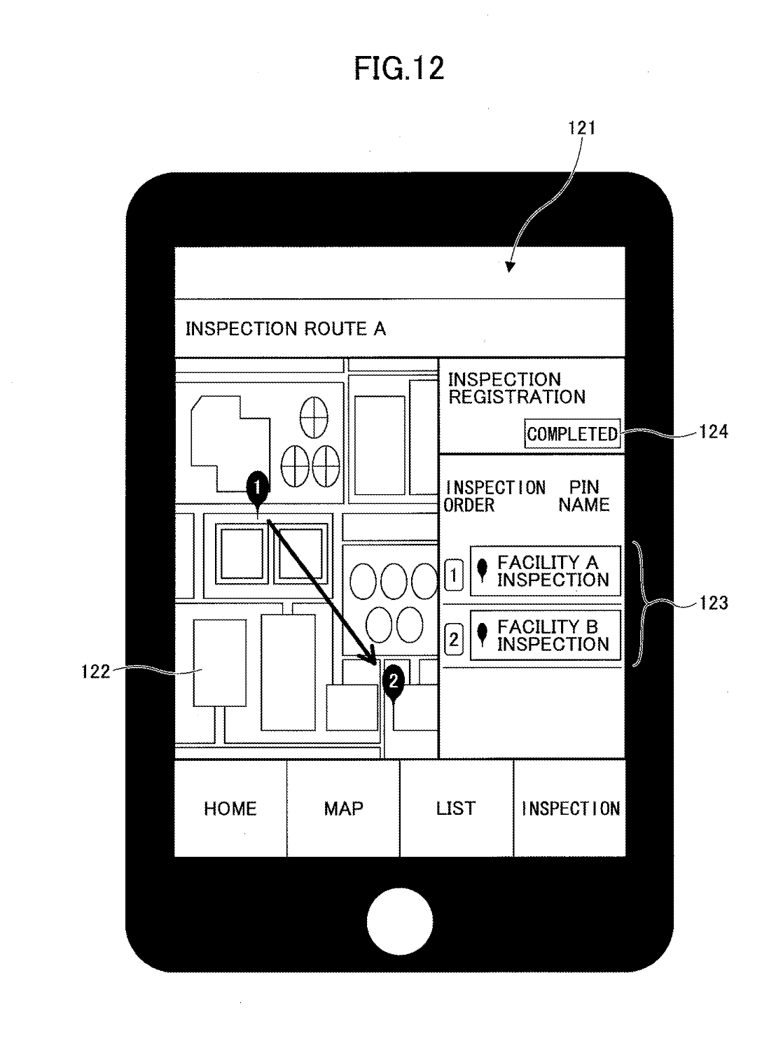

FIG. 12 is a drawing illustrating a screen 121 displaying inspection points and an inspection order. The screen 121 displays a map 122 including a pin ID at the top of pin IDs included in a selected inspection route A, and an inspection order 123 indicating the order in which the pin IDs in the inspection route A are inspected.

In the example of FIG. 12, an inspection pin with a name “facility A inspection” indicates the first inspection point, and an inspection pin 2 with a name “facility B inspection” indicates the next inspection point.

When, for example, the inspection pin 1 is pressed (or touched) by an inspector, the terminal 200 determines that inspection of the inspection pin 1 has been started, and displays an input screen corresponding to the inspection pin 1. Details of the input screen are described later.

The screen 121 also displays a completion report button 124 used to report completion of inspection. When the completion report button 124 is pressed, the terminal 200 determines that the inspection of all inspection pins listed in the inspection order 123 has been completed, and prevents display of input screens thereafter.

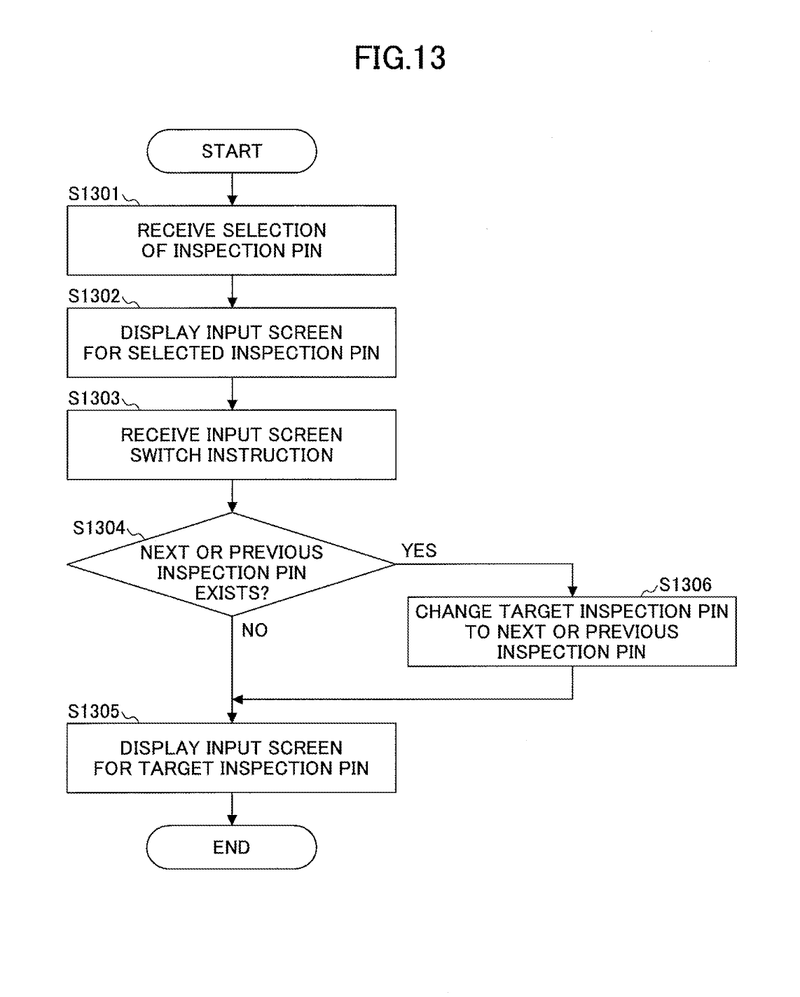

Next, an exemplary process of displaying input screens by the terminal 200 is described with reference to FIG. 13. FIG. 13 is a flowchart illustrating an exemplary process of displaying input screens for entering inspection results.

After an inspection route is selected and a screen including inspection points is displayed, the terminal 200 receives a selection of an inspection pin corresponding to one of the inspection points (step S1301). Next, the display controller 212 of the terminal 200 sets the selected inspection pin as a target inspection pin, and displays an input screen corresponding to the target inspection pin (step S1302).

More specifically, when an inspection pin is selected, the display controller 212 obtains an input item corresponding to the selected inspection pin from the pin definition database 310, and displays an input screen including an input field corresponding to the obtained input item on the display console 21.

Next, the input receiver 211 of the terminal 200 receives an input screen switch instruction to switch the current input screen to another input screen corresponding to an inspection pin immediately preceding or following the target inspection pin in the inspection order of the inspection route (step S1303). When receiving the input screen switch instruction, the terminal 200 refers to the route definition database 330 to determine whether an inspection pin immediately preceding or following the target inspection pin exists (step S1304).

In the descriptions below, it is assumed that the received input screen switch instruction is to switch the current input screen to another input screen corresponding to a previous inspection pin immediately preceding the target inspection pin.

When it is determined at step S1304 that the previous inspection pin does not exist, the display controller 212 sets the inspection pin selected at step S1301 as the target inspection pin (i.e., does not change the target inspection pin), and continues to display the current input screen (step S1305).

When it is determined at step S1304 that the previous inspection pin exists, the display controller 212 changes the target inspection pin to the previous inspection pin (step S1306), and proceeds to step S1305. In this case, the display controller 212 displays an input screen corresponding to the changed target inspection pin (i.e., the previous inspection pin) at step S1305.

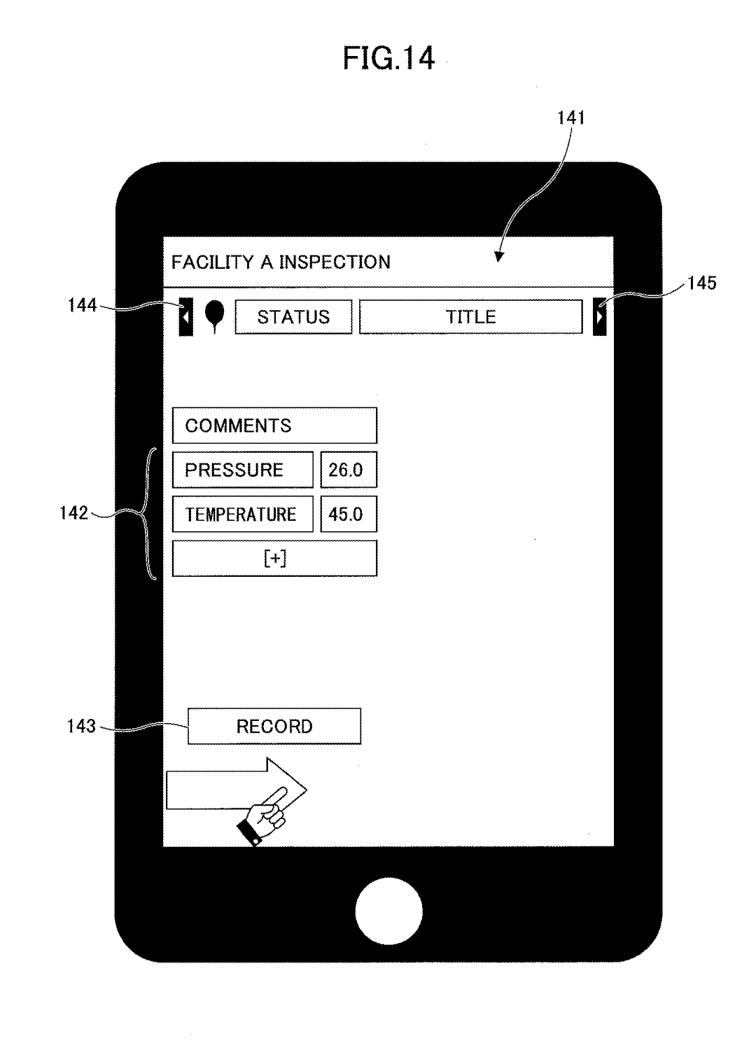

Next, an exemplary input screen is described with reference to FIG. 14. FIG. 14 is a drawing illustrating an exemplary input screen 141 corresponding to the inspection pin 1 with a pin ID “P0001”.

Input items corresponding to the pin ID “P0001” are “temperature” and “pressure” (see FIG. 2). Accordingly, the input screen 141 displays input fields 142 for entering a temperature and a pressure. The input screen 141 also displays a record button 143. For example, when the record button 143 is pressed after values are entered in the input fields 142, the terminal 200 sends the entered values and the date and time when the record button 143 is pressed to the server 200.

The input screen 141 further displays switch buttons 144 and 145 for switching screens. For example, when the switch button 144 is pressed, the terminal 200 switches the input screen 141 to an input screen corresponding to an inspection pin that is inspected before the inspection pin 1.

Similarly, when the switch button 145 is pressed, the terminal 200 switches the input screen 141 to an input screen corresponding to an inspection pin that is inspected after the inspection pin 1.

The display controller 212 may also be configured to switch the input screen 141 to the screen 121 when a flick gesture is performed on the input screen 141. The screen 121 displays a map including the inspection pin 1 corresponding to the input screen 141.

As described above, the terminal 200 of the present embodiment can display input screens corresponding to inspection pins in an order different from the inspection order of an inspection route. Thus, the present embodiment makes it possible to partially change the order of entering inspection results for inspection points in an inspection route, and thereby makes it possible to perform inspection in an appropriate order when, for example, it is difficult or inappropriate to perform inspection in a predetermined order.

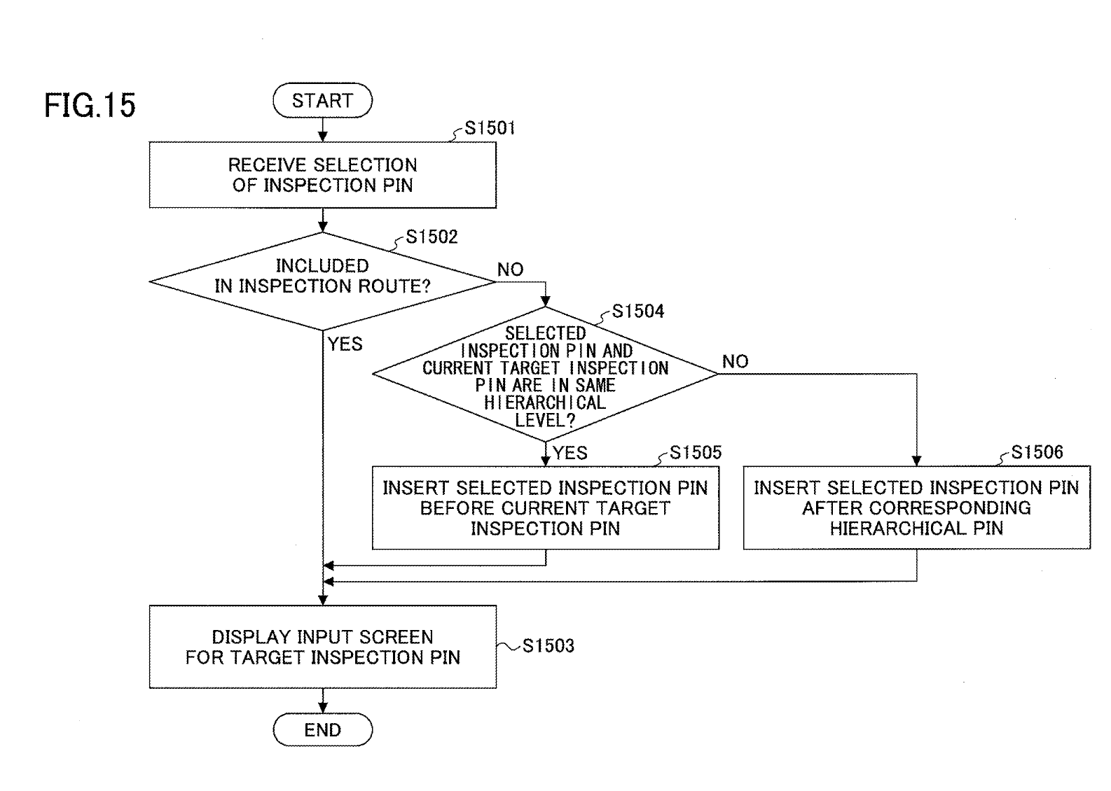

Next, an exemplary process performed by the terminal 200 to insert an inspection pin is described. FIG. 15 is a flowchart illustrating an exemplary process of inserting an inspection pin.

The input receiver 211 of the terminal 200 receives a selection of an inspection pin on a map displayed on the display console 21 (step S1501). Next, the pin position determiner 218 determines whether the selected inspection pin is included in the inspection route being inspected (step S1502). When it is determined at step S1502 that the selected inspection pin is included in the inspection route, the display controller 212 sets the selected inspection pin as a target inspection pin, displays an input screen for the target inspection pin (step S1503), and ends the process.

When it is determined at step S1502 that the selected inspection pin is not included in the inspection route, the hierarchical level determiner 217 determines whether a map including the selected inspection pin is in the same hierarchical level as a map including an inspection pin currently being set as the target inspection pin (current target inspection pin) (step S1504). More specifically, the hierarchical level determiner 217 determines whether the selected inspection pin and the current target inspection pin are in the same map. The current target inspection pin is, for example, an inspection pin corresponding to the last input screen used to enter an inspection result before the map is displayed at step S1501.

When it is determined at step S1504 that the selected inspection pin and the current target inspection pin are in the same hierarchical level (or map), the pin inserter 219 inserts the selected inspection pin before the current target inspection pin in the inspection order of the inspection route (step S1505), and the process proceeds to step S1503.

When it is determined at step S1504 that the selected inspection pin and the current target inspection pin are in different hierarchical levels, the pin inserter 219 inserts the selected inspection pin after a hierarchical pin, which indicates a map in the hierarchical level of the selected inspection pin, in the inspection order of the inspection route (step S1506), and the process proceeds to step S1503.

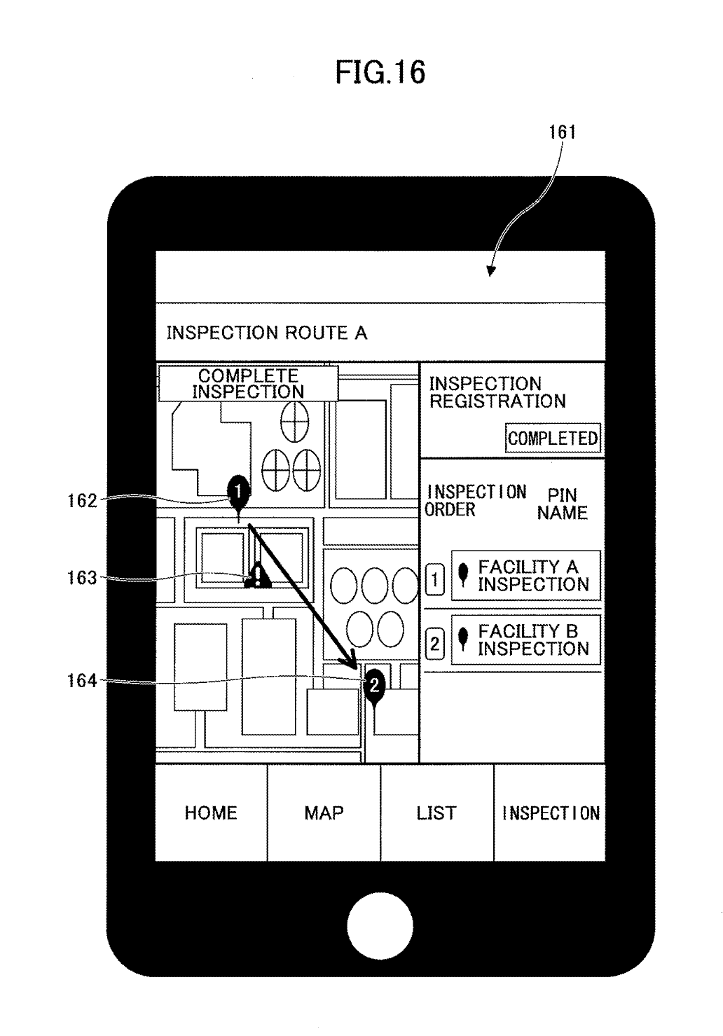

The process of inserting an inspection pin is further described below with reference to FIG. 16. FIG. 16 is a drawing illustrating an exemplary screen 161 used to describe insertion of an inspection pin.

Here, it is assumed that a map in the screen 161 is displayed after an inspection result is entered on an input screen corresponding to an inspection pin 162. When an inspection pin 163 is selected on the screen 161, the pin position determiner 218 determines whether the inspection pin 163 is included in the inspection route being inspected.

In the example of FIG. 16, the inspection route A is being inspected, and the inspection pin 163 is not included in the inspection route A. The hierarchical level determiner 218 determines whether the inspection pin 163 is in the same hierarchical level as the inspection pin 162. In the screen 161, the inspection pin 162 and the inspection pin 163 are displayed on the same map and are therefore in the same hierarchical level.

Accordingly, the pin inserter 219 inserts the inspection pin 163 in the inspection route A at a position after the inspection pin 162 (“facility A inspection” that is the first pin in the inspection order) and before an inspection pin 164 (“facility B inspection” that is the second pin in the inspection order). The inspection pin 162 corresponds to the last input screen used to enter an inspection result before the screen 161 is displayed.

As described above, the present embodiment makes it possible to add an inspection pin to an inspection route. That is, according to the present embodiment, even when an inspection point that needs to be inspected but is not included in an inspection route is unexpectedly found out during the inspection of the inspection route, it is possible to enter an inspection result of the inspection point. Also according to the present embodiment, it is possible to easily continue the inspection of the inspection route according to its original inspection order after the unexpected inspection of the inspection point is performed.

Next, an exemplary process of displaying maps by the terminal 200 is described. According to the present embodiment, when an inspector moves from the current inspection point to the next inspection point, the terminal 200 can switch maps to show a route to the next inspection point.

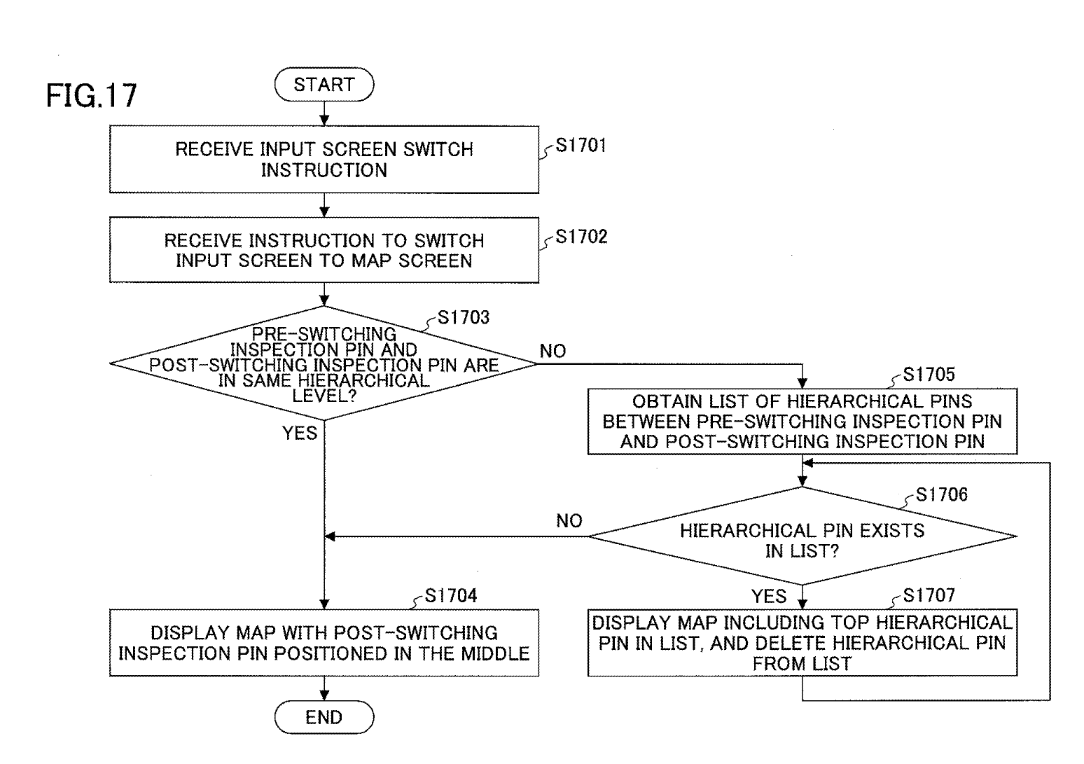

FIG. 17 is a flowchart illustrating an exemplary process of switching maps.

On an input screen (pre-switching input screen) corresponding to an inspection pin (pre-switching inspection pin), the input receiver 211 receives an input screen switch instruction to switch the pre-switching input screen to another input screen (post-switching input screen) corresponding to the next inspection pin or the previous inspection pin (post-switching inspection pin) in the inspection order (step S1701). The display controller 212 switches the pre-switching input screen to the post-switching input screen according to the input screen switch instruction.

Next, on the post-switching input screen, the input receiver 211 receives an instruction to switch the post-switching input screen to a map screen (step S1702). In this case, the display controller 212 displays a map such that the pre-switching inspection pin corresponding to the pre-switching input screen is positioned in the middle of the map screen. This makes it possible to switch the post-switching input screen to the pre-switching input screen.

Next, the hierarchical level determiner 217 determines whether the hierarchical level of a map including the pre-switching inspection pin is the same as the hierarchical level of a map including the post-switching inspection pin (step S1703).

When it is determined at step S1703 that the maps are in the same hierarchical level, the display controller 212 adjusts the display of the map displayed at step S1702 such that the post-switching inspection pin corresponding to the post-switching input screen is positioned in the middle of the map screen (step S1704).

When it is determined at step S1703 that the maps are in different hierarchical levels, the hierarchical level determiner 217 refers to the pin definition database 310 and the route definition database 330 to obtain a list of one or more hierarchical pins that exist between the pre-switching inspection pin and the post-switching inspection pin in the inspection route (step S1705).

Next, the hierarchical level determiner 217 determines whether one or more hierarchical pins are in the list (step S1706).

When it is determined at step S1706 that one or more hierarchical pins are in the list, the display controller 212 displays a map including a hierarchical pin at the top of the list, and deletes the hierarchical pin from the list (step S1707), and the process returns to step S1706.

When it is determined at step S1706 that no hierarchical pin is in the list, the terminal 200 proceeds to step S1704. In this case, at step S1704, the display controller 212 displays a map associated with the post-switching inspection pin such that the post-switching inspection pin is positioned in the middle.

With the above process, the terminal 200 can display a route from an inspection point indicated by the pre-switching inspection pin to an inspection point indicated by the post-switching inspection pin through different hierarchical levels.

The above process of switching maps is further described below based on an assumption that the inspection route A is being inspected, the pre-switching inspection pin is an inspection pin P2 with a pin ID “P0002”, and the post-switching inspection pin is an inspection pin P4 with a pin ID “P0004”.

When an instruction to switch an input screen to a map screen, the display controller 212 displays a map such that the pre-switching inspection pin P2 is positioned in the middle of the map screen. This makes it possible to switch the post-switching input screen corresponding to the post-switching inspection pin P4 to the pre-switching input screen corresponding to the pre-switching inspection pin P2.

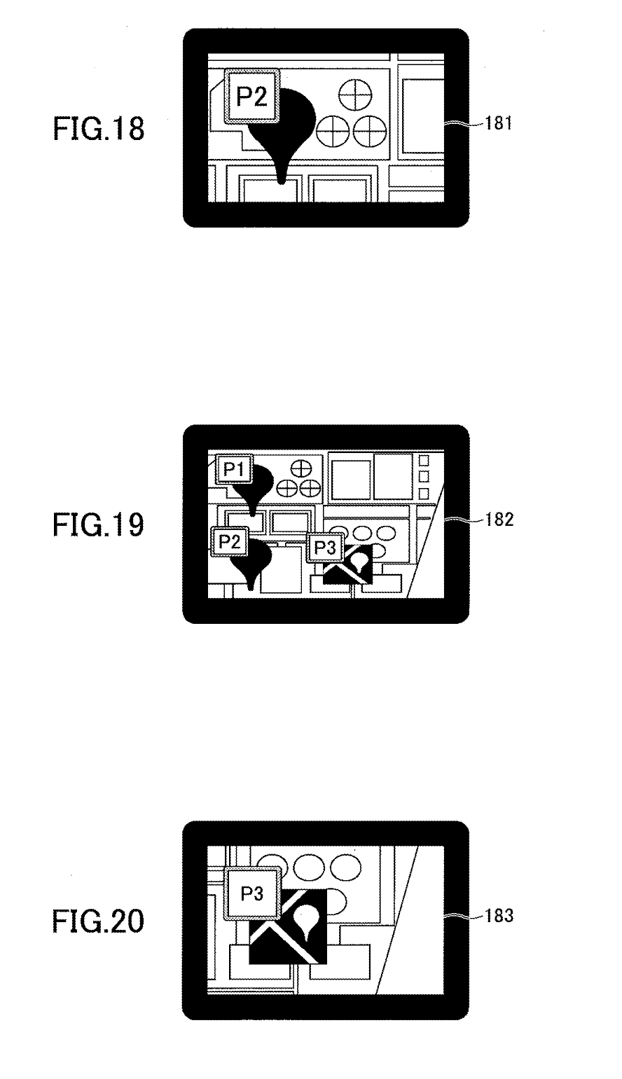

FIG. 18 is a drawing illustrating an exemplary map screen 181. In the map screen 181, a map “M0001” with a map ID “M0001” is displayed such that the pre-switching inspection pin P2 is positioned in the middle.

Next, the hierarchical level determiner 217 refers to the pin definition database 310 to determine whether the inspection pin P2 and the inspection pin P4 are in the same hierarchical level. In this example, the inspection pin P2 is included in the map “M0001” and the inspection pin P4 is included in a map “M0002” with a map ID “M0002”. Accordingly, the inspection pin P2 and the inspection pin P4 are in maps of different hierarchical levels.

In this case, the hierarchical level determiner 217 refers to the pin definition database 310 and the route definition database 330 to obtain a list of one or more hierarchical pins in a route from the inspection pin P2 to the inspection pin P4. In this example, the obtained list includes a hierarchical pin P3 with a pin ID “P0003”.

The display controller 212 displays a map (associated map) associated with the hierarchical pin P3 at the top of the list, and deletes the hierarchical pin P3 from the list.

In this example, the map associated with the hierarchical pin P3 is the map “M0001”, and the display controller 212 displays the map “M0001”.

FIG. 19 is a drawing illustrating an exemplary map screen 182 displayed by the display controller 212. In the map screen 182, the map “M0001” including the hierarchical pin P3 is displayed.

After displaying the map screen 182, the display controller 212 may display a map screen 183 as illustrated by FIG. 20 where the map “M0001” is displayed such that the hierarchical pin P3 is positioned in the middle.

Next, the hierarchical level determiner 217 determines whether one or more hierarchical pins are left in the list. In this example, no hierarchical pin is left in the list.

Accordingly, the display controller 212 displays a map associated with the post-switching inspection pin P4 such that the post-switching inspection pin P4 is positioned in the middle. Before displaying the map with the inspection pin P4 positioned in the middle, the display controller 212 may display the entire map associated with the inspection pin P4.

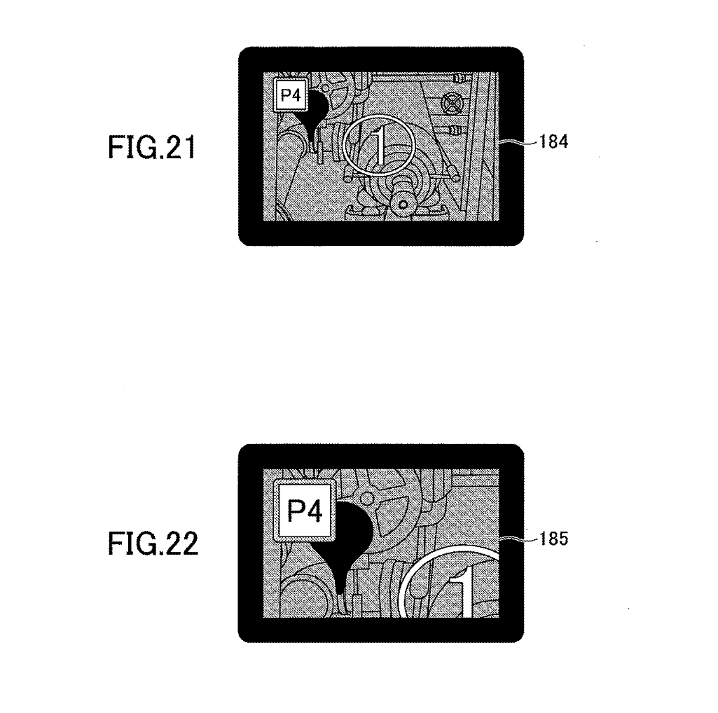

FIG. 21 is a drawing illustrating an exemplary map screen 184. In the map screen 184, the entire map associated with the inspection pin P4 is displayed. In this example, the map associated with the inspection pin P4 is the map “M0002”, and therefore the display controller 212 displays the map “M0002” in the map screen 184.

FIG. 22 is a drawing illustrating an exemplary map screen 185. In the map screen 185, the map “M0002” is displayed such that the inspection pin P4 is positioned in the middle.

Thus, in the above exemplary process, when an input screen for the inspection pin P2 is switched to an input screen for the inspection pin P4 and the input screen is switched to a map screen, the terminal 200 displays a route from the inspection pin P2 to the inspection pin P4 by switching maps. Also, when the inspection pin P2 and the inspection pin P4 belong to maps in different hierarchical levels, the terminal 200 displays the route through the different hierarchical levels by switching the maps.

Thus, the present embodiment makes it possible for an inspector to easily remember a moving route from an inspection point indicated by the pre-switching inspection pin to an inspection point indicated by the post-switching inspection pin. This in turn makes it possible to prevent an inspector from getting lost in a facility or taking a roundabout route to the next inspection point, and thereby makes it possible to reduce the load of inspection work.

Although not illustrated in FIGS. 18 through 22, the names of the corresponding maps may be displayed in the screens 181 through 185. Displaying the names of maps makes it easier for an inspector to easily identify the location displayed on a screen.

An aspect of this disclosure makes it possible to provide a storage medium, a facility inspection support method, and a facility inspection support apparatus that can change a predetermined inspection order.

All examples and conditional language provided herein are intended for the pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing therein a program that causes a computer to execute a process comprising:
displaying pointers indicating inspection points on a map of a facility;
displaying a first input screen for receiving an inspection result of an inspection point corresponding to a first pointer of the pointers;
receiving an input that is an instruction for switching to another screen from the first input screen; and
in response to the input, allowing the first input screen to be switched to a second input screen for receiving an inspection result of an inspection point corresponding to a second pointer of the pointers that precedes the first pointer in a predetermined order of inspection.

2. The non-transitory computer-readable storage medium as claimed in claim 1, the process further comprising:
receiving a completion instruction indicating completion of inspection of the facility; and
preventing the first input screen from being switched to the second input screen after the completion instruction is received.

3. A non-transitory computer-readable storage medium storing therein a program that causes a computer to execute a process comprising:
displaying pointers indicating inspection points on a map of a facility, the pointers including a first pointer indicating a first inspection point and a second pointer indicating a second inspection point, the first inspection point succeeding the second inspection point in an order of inspection;
when the second pointer is selected in the middle of or after entering an inspection result of the first inspection point on a first input screen, allowing to enter an inspection result of the second inspection point on a second input screen; and
after the inspection result of the second inspection point is entered, allowing to switch the second input screen to the first input screen.

4. The non-transitory computer-readable storage medium as claimed in claim 3, the process further comprising:
after the inspection result of the second inspection point is entered, receiving an instruction to display the map; and
displaying the map such that the first pointer is positioned in a middle of the map.

5. The non-transitory computer-readable storage medium as claimed in claim 3, the process further comprising:
when the first pointer and the second pointer are associated with maps in different hierarchical levels, displaying a route from the first pointer to the second pointer through the different hierarchical levels by switching the maps.

6. A computer-implemented method, comprising:
displaying pointers indicating inspection points on a map of a facility;
displaying a first input screen for receiving an inspection result of an inspection point corresponding to a first pointer of the pointers;
receiving an input that is an instruction for switching to another screen from the first input screen; and
in response to the input, allowing the first input screen to be switched to a second input screen for receiving an inspection result of an inspection point corresponding to a second pointer of the pointers that precedes the first pointer in a predetermined order of inspection.

7. A facility inspection support apparatus, comprising:
a processor configured to execute a process including
displaying pointers indicating inspection points on a map of a facility;
displaying a first input screen for receiving an inspection result of an inspection point corresponding to a first pointer of the pointers;
receiving an input that is an instruction for switching to another screen from the first input screen; and
in response to the input, allowing the first input screen to be switched to a second input screen for receiving an inspection result of an inspection point corresponding to a second pointer of the pointers that precedes the first pointer in a predetermined order of inspection.
